(19) United States
(12) Patent Application Publication
(10) Pub. No.: US 2025/0362456 A1
(43) Pub. Date: Nov. 27, 2025

(54) GRADED INDEX (GRIN) LENS EXPANDED BEAM (EB) COUPLER FOR DETACHABLE FIBER ARRAY UNIT (FAU)

(71) Applicant: Intel Corporation, Santa Clara, CA (US)

(72) Inventors: Feifei Cheng, Chandler, AZ (US); Dekang Chen, Chandler, AZ (US); Fan Fan, Chandler, AZ (US); Ziyin Lin, Chandler, AZ (US); Li Yuan, Fremont, CA (US); Zhichao Zhang, Chandler, AZ (US); Saikumar Jayaraman, Chandler, AZ (US); Kumar Abhishek Singh, Phoenix, AZ (US)

(73) Assignee: Intel Corporation, Santa Clara, CA (US)

(21) Appl. No.: 18/673,117

(22) Filed: May 23, 2024

(51) Int. Cl. G02B 6/30

(52) U.S. Cl. CPC G02B 6/30

(57) ABSTRACT

Architectures and methods for graded index (GRIN) lens expanded beam (EB) coupler for detachable fiber array unit (FAU) for use with a photonic integrated circuit (PIC). A system to optically couple a fiber optic array (FAU) to a PIC die includes a graded index (GRIN) lens to optically couple a single mode fiber (SMF) in the FAU to a waveguide in the PIC die. The GRIN lens has a first mode field diameter (MFD) that is a function of a spot size converter of the waveguide. The SMF is a conduit for optical light with a wavelength and a second MFD. The GRIN lens has a length that is a function of a predetermined whole number of periodic cycles of the wavelength.

### BACKGROUND

The rapid rise of the digital economy and intra-datacenter traffic has increased demand for advanced packaging components with interconnects with high bandwidth and power efficiency. A variety of photonics Co-packaged Optics (CPO) components implement silicon photonics components, such as photonic integrated circuits (PICs), to meet the high-bandwidth and power efficient input/output (IO) requirements. However, technical challenges to the scalability and high-volume manufacturing support for these advanced packaging components remain.

### BRIEF DESCRIPTION OF THE DRAWINGS

FIGS. 1A, 1B, and 1C are simplified views of an exemplary photonic integrated circuit (PIC) die, in accordance with various embodiments.

FIG. 2A-2B illustrate various features of a V-groove, as referenced herein.

FIG. 2C enables a discussion of the method for passive-active optical alignment of embodiments described herein.

FIG. 3 illustrates a GRIN FAU block coupled to a PIC die, in accordance with various embodiments.

FIG. 4A illustrates an exemplary GRIN lens component, in accordance with various embodiments.

FIG. 4B illustrates the radial gradient of a grin lens.

FIG. 4C illustrates the periodic propagation of light within a GRIN lens.

FIG. 5 is an exemplary method for making a system including a GRIN lens EB coupler component for a detachable FAU, in accordance with various embodiments.

FIG. 6 is a method for a GRIN lens EB coupler component for a detachable FAU, in accordance with various embodiments.

FIG. 7 is a top view of a wafer and dies that may be included in a microelectronic assembly, in accordance with any of the embodiments disclosed herein.

FIG. 8 is a simplified cross-sectional side view showing an implementation of an integrated circuit on a die that may be included in various embodiments, in accordance with any of the embodiments disclosed herein.

FIG. 9 is a cross-sectional side view of a microelectronic assembly that may include any of the embodiments disclosed herein.

FIG. 10 is a block diagram of an example electrical device that may include any of the embodiments disclosed herein.

### DETAILED DESCRIPTION

The following detailed description is merely exemplary in nature and is not intended to limit the application and uses. It may be evident that the novel embodiments can be practiced without every detail described herein. For the sake of brevity, well known structures and devices may be shown in block diagram form to facilitate a description thereof.

Many advanced packaging components use a silicon photonic integrated circuit (PIC) component for the input/output (I/O) to optically connect to a fiber array unit (FAU). The PIC components generally provide an IO with the advantages of low loss, a compact size, lower power, and higher-bandwidth interconnect capabilities than a silicon IO.

Ensuring a robust interface (i.e., optimized optical alignment) between the PIC and the FAU is technically challenging, at least in part due to the micron and sub-micron dimensions, and the different beam sizes and modes between an edge coupler of the PIC and the input to the fiber array in the FAU. These challenges are further exacerbated by the demands of scalability and high-volume manufacturing (HVM).

As used herein, optical co-packaging refers to heterogeneously integrating PIC components into advanced packaging components, such as chips, interposers, couplers, and the like, for a wide range of applications. The resulting optical co-packaged components are sometimes referred to as photonics Co-packaged Optics (CPO) components, or simply CPO components. Some non-limiting example applications that utilize these CPO components include Datacenter Networking, AI/High Performance Computing, and Disaggregated systems.

In the CPO components, the primary optical loss from coupling the FAU and PIC is insertion Loss (IL). IL is an optical loss that occurs at the coupling interface between the Fiber Attached Unit (FAU) and Photonic Integration Circuit (PIC). Due to the inherently short wavelengths of the optical communication between the FAU and PIC (e.g., in various embodiments, between 1.31 microns (μm) and 1.55 μm, +/−10%), and the mode field diameter (MFD) of both single mode fiber (SMF) and the PIC typically being less than 10 μm, it is technically challenging to realize a low IL at the FAU-PIC coupling interface.

The coupling efficiency of the FAU-PIC interface is determined by the integrated overlap of the optical modes in the SMF of the FAU and the PIC. Even a misalignment of 1˜2 μm between the SMF and PIC can result in a significant optical loss with coupling. Available technologies of FAU assembly with a PIC component have substantial difficulty staying within even this misalignment range. Moreover, assembling a pluggable FAU-PIC coupling interface, in which the possible misalignment is inherently larger, provides even more of a technical challenge to available technologies for FAU assembly.

Since the difficulty of FAU-PIC alignment arises from the small mode field diameter (MFD), the most direct solution for relaxing alignment tolerance is to increase the MED. Consequently, expanded beam (EB) connectors that increase the MFD have emerged as a promising strategy for pluggable optical connectors in CPO components. However, available EB connectors utilize a block of convex micro-lens arrays (MLA) to increase the MFD, and because convex lenses, whether constructed from glass or silicon, typically need a MLA diameter on the order of several hundreds of microns to maintain the quality of the central curved surface, these MLA blocks can be respectively large. This MLA diameter is significantly larger than the diameter of often used SMF (which is generally 125 μm) and substantially enlarges the dimensions of the FAU-PIC coupling interface, making it difficult to integrate them in a CPO component package. As a result, solutions that utilize convex MLA blocks must be positioned outside a PIC package, necessitating an additional segment of fiber to guide the optical mode back to the PIC package. This solution has the disadvantage of not only substantially reducing the compactness of the CPO component, but also introduces an extra interface between the receiver lens and the optical fiber, leading to a further increase in optical loss from coupling.

In addition to the above, achieving mode field matching between the Single-Mode Fiber (SMF) of the FAU and the Spot Size Converter (SSC) on the PIC is technically challenging. As mentioned, the MLA-block connector necessitates the integration of an additional segment of SMF to establish a connection between the MLA and the PIC package; therefore, an optical interface between the additional segment of SMF and the PIC package is created on the optical path. To minimize the additional optical coupling loss at this interface, ensuring that their Mode Field Diameters (MFDs) are compatible between SMF of the FAU and the spot size converter (SSC) of the PIC are desirable.

As such, it is desirable for the MFD from the SSC of the PIC (referred to herein as spot size, to distinguish from the MFD of the SMF) to expand to the same scale as the MFD of the SMF (FAU), which, in various embodiments, may be about 9.2 μm at the O band and even larger, such as, about 10.4 μm, at the C band; wherein about means plus or minus 10%. For reference, the O band may include wavelengths in the range of about 1260 to 1360 nanometers (nm) and the C band may be in a range of about 1530 to 1565 nm. However, achieving this scale of expansion in the MFD on the PIC using conventional SSC is impractical due to inherent physical limitations. Typically, with a standard edge-inverted taper (EIT), the maximum attainable MFD using conventional SSC on the PIC is limited to approximately 3 to 5 microns, resulting in an additional optical coupling loss of about 1 to 2 dB to the total optical path.

Recently, more complex EIT designs, such as those utilizing metamaterial membrane tapers, have been proposed to achieve up to a 9 μm MFD on the PIC. As used herein, a metamaterial membrane taper refers to a taper with grating structures, and the effective refractive index of the taper can be tuned by adjusting the size and spacing of the grating structures (referred to as the volume fraction) as desired, thereby achieving an 8-9 μm MFD. However, these more complex EIT designs are associated with significantly increased process costs, and the implementation of such large MFDs on a Silicon-on-Insulator (SOI) platforms necessitates substrate undercutting and subsequent infilling with Index-Matching-Material (IME) to prevent mode leakage into the silicon substrate, substantially complicating the co-packaging process and posing challenges in terms of yield, reliability, mechanical structural integrity and immersion cooling.

The present disclosure provides a technical solution to the above-described technical problems related to scalable optical packaging and high-volume manufacturing (HVM) with PIC components and provides an improvement over the limitations of available solutions, in the form of a Gradient Index (GRIN) lens-based expanded beam (EB) coupler for detachable/pluggable optical co-packaging with a fiber array unit (FAU) (also shortened herein to “GRIN lens EB coupler” apparatus, architecture, or system, based on context).

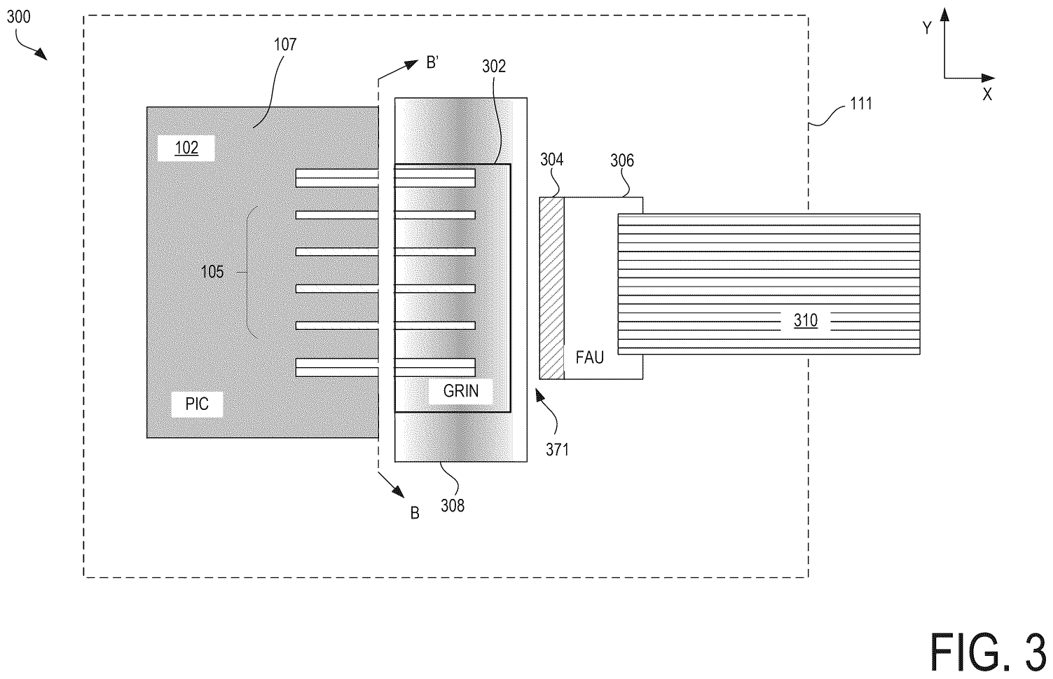

Embodiments enable a detachable EB FAU solution (see, e.g., GRIN FAU block 308, FIG. 3) that has the benefits of a relaxed offset tolerance, less sensitivity to dust and contamination, better field serviceability, and a better package yield. Because embodiments use a GRIN lens with the width/diameter that is the same size as single-mode fiber (SMF), the provided GRIN lens EB coupler can utilize existing, widely used, industry standard PIC V-groove architecture and fiber alignment processes to save cost. Embodiments can significantly improve the accuracy, yield/cost, assembly throughput, reliability, and performance of optical co-packaging, which is one of the most technically challenging aspects of optical module or multi-die assembly. Embodiments may be detected with examination using an optical microscope to find the features and locations of features with respect to each other, as described herein. These concepts are further developed below.

Exemplary embodiments will hereinafter be described in conjunction with the following drawing figures, wherein like numerals denote like elements. Figures are not necessarily to scale but may be relied on for spatial orientation and relative positioning of features. As may be appreciated, certain terminology, such as “ceiling” and “floor”, as well as “upper,”, “uppermost”, “lower,” “above,” “below,” “bottom,” and “top” refer to directions based on viewing the Figures to which reference is made. Further, terms such as “front,” “back,” “rear,”, “side”, “vertical”, and “horizontal” may describe the orientation and/or location of portions of the component within a consistent but arbitrary frame of reference which is made clear by reference to the text and the associated Figures describing the component under discussion. Such terminology may include the words specifically mentioned above, derivatives thereof, and words of similar import.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

The term “overlaid” (past participle of “overlay”) may be used to refer to a layer to describe a location and orientation for the layer but does not imply a method for achieving the location and orientation. For example, a first layer overlaid on a second layer, or overlaid on a component means that the first layer is spread across or superimposed on the second layer or component. Alternately stated, a layer that is overlaid on a second layer may appear in a cross-sectional view as “adjacent” to the second layer, as described above.

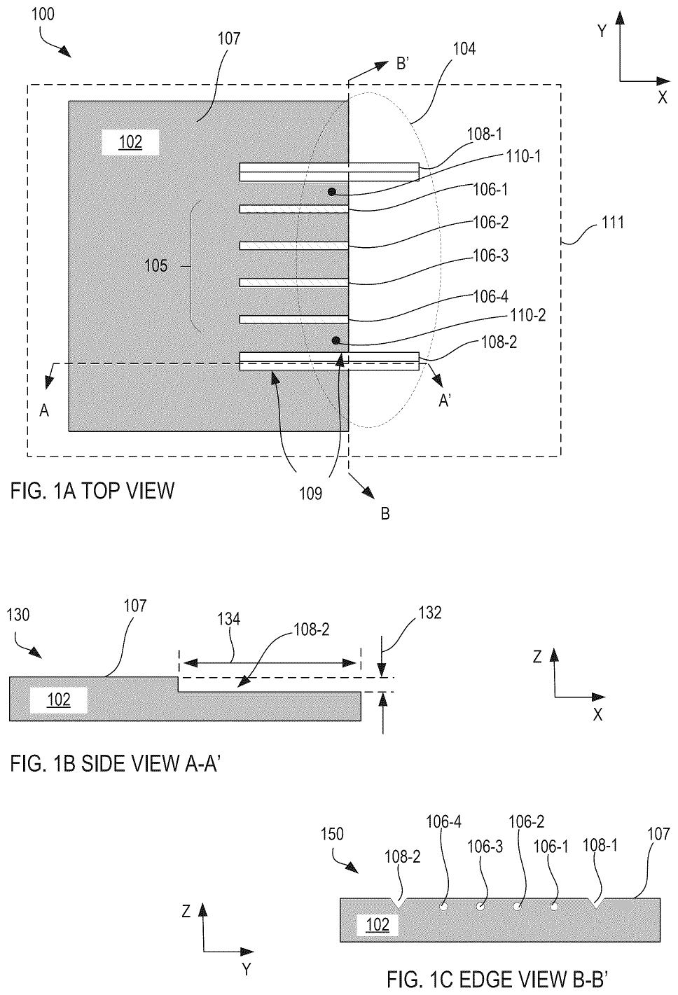

FIGS. 1A, 1B, and 1C are simplified views of an exemplary photonic integrated circuit (PIC) die, in accordance with various embodiments. A semiconductor substrate including a photonic integrated circuit (PIC) is indicated as PIC 102 die. In various embodiments, the PIC 102 may be found on a package substrate 111. As may be appreciated, the PIC 102 die includes a miniaturized circuit that integrates various electric and photonic components, such as lasers, modulators, detectors, and waveguides. The PIC 102 die includes one or more optical channels or waveguides. Waveguides in the silicon PIC 102 die may be referred to herein as “main waveguides” to distinguish them from waveguides found in an external optical component (e.g., an FAU, described below). Many PICs 102 have a plurality of main waveguides arranged in a waveguide array 105 (simplified in the illustration, showing only four main waveguides). Individual main waveguides are conduits for optical light with a given wavelength and may be routed differently around the silicon substrate and then collectively terminate at an array coupler interface located at a portion 104 of the PIC 102.

The array coupler interface is a facet or architecture to optically couple the PIC die 102 to external optical components, as described in more detail below. The array coupler interface may be embodied as edge couplers or as vertical couplers. In the non-limiting example in FIG. 1A, the array coupler interface 106 can be embodied as a multiple channel edge array coupler, e.g., ch1: 106-1, ch2; 106-2, ch3: 106-3, and ch4: 106-4.

The PIC 102 die may have a silicon substrate layer or core of about 250-750 microns thick (wherein “about” means plus or minus 10%). The main waveguides of the waveguide array 105 may comprise silicon nitride. The main waveguides of the waveguide array 105 may be encased in a transparent dielectric material or cladding layer comprising oxygen and may include silicon dioxide. In practice, it may be difficult to distinguish the transparent dielectric material from the substrate layer in a cross-sectional scanning electron microscopy image (SEM), however, a non-limiting way to identify the described embodiments is to visually inspect both the materials present in a top down and/or cross-sectional view and the structure and shape of the materials to determine that the described embodiments have been implemented.

The PIC die 102 includes a surface 107. In various embodiments, the surface 107 may include two or more parallel V-grooves. As used herein, a V-groove is a V-shaped channel typically created by etching a surface of a thin layer of material such as silicon, silica, quartz, or other suitable material. Respective V-grooves comprise two opposing sidewalls 109. The sidewalls 109 are substantially two-dimensional planes. When implemented, the V-grooves are substantially parallel, as shown: the first V-groove 108-1 is substantially parallel to the second V-groove 108-2. As indicated in views 100 and 130, the V-grooves may have depth 132 and length 134.

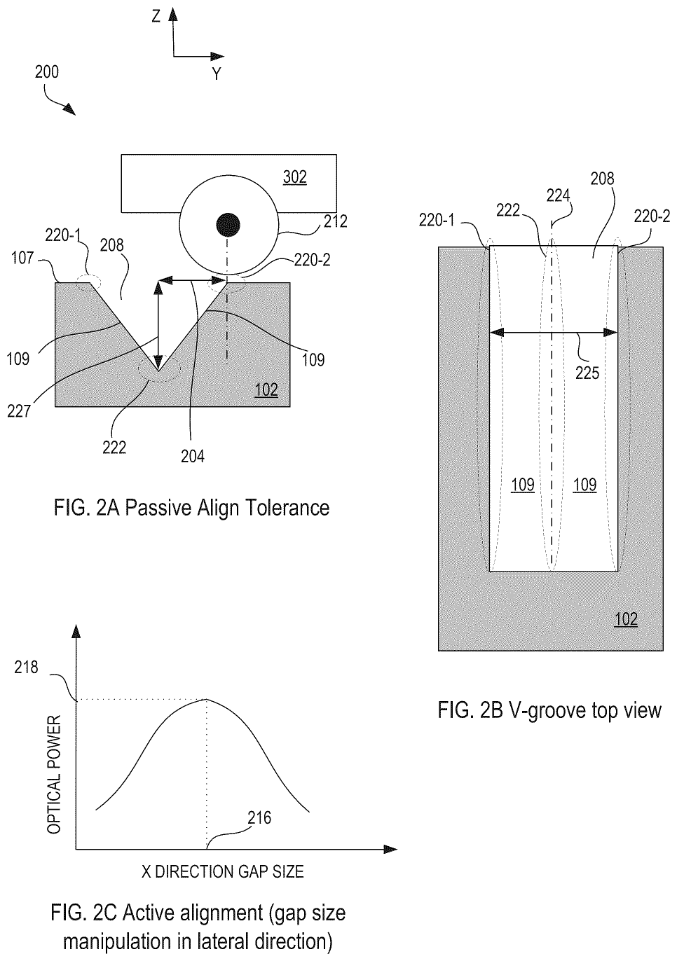

FIG. 2A and FIG. 2B further illustrate the optional V-grooves. FIG. 2C enables a discussion of the method for passive optical alignment using the V-grooves. The sidewalls 109 of the V-groove have a respective shoulder or surface edge (220-1, 220-2) identified at the surface 107. The surface edges (220-1, 220-2) are substantially parallel at the surface 107, e.g., maintaining substantially the same width 225 throughout, and the sidewalls 109 slope downward therefrom into the material to meet at a longitudinal axis 224. The V-groove (108-1, 108-2, 208) has the depth 227, measured from the surface 107, that remains substantially equal along the length 134.

In various embodiments, the two planar sidewalls 109 have a mirror image angle (plus or minus about 5 degrees) measured from the surface 107 to the longitudinal axis 224 where they meet; the angle being less than about 90 degrees. In various embodiments, the angle of the slope of the sidewalls is 60 degrees plus or minus 10 degrees. In a scanning electron microscopic (SEM) image, the surface edges (220-1, 220-2) of a V-groove may be rounded, and the bottom 222 of the V-groove may be rounded.

In the non-limiting example, a first V-groove 108-1 is located external to a first side of the array coupler interface 106, and a second V-groove 108-2 is located external to a second side of the array coupler interface, both V-grooves are open at the surface 107. The respective longitudinal axis 224 of the one or more V-grooves are substantially parallel to each other. In some embodiments, the V-grooves have a terminal that is open at an edge of the PIC die 102 (e.g., the edge indicated with the cutout B-B′), or have at least one missing sidewall, located at an edge of the PIC die (cutaway B-B′), also illustrated in FIGS. 1A-1C. However, in other embodiments, the V-grooves have all four sidewalls intact, and are not open on an edge.

In various aspects of the disclosure, the V-grooves 108-1 and 108-2 straddle the array coupler interface 106. Fiducial markers 110 may be implemented on the surface 107, generally in the portion 104, by a respective V-groove, to aid the operation of pick and place equipment. The figure indicates the fiducial marker 110-1 and the fiducial marker 110-2. In various embodiments, the array coupler interface may be located on an edge of the PIC die 102 (edge coupling), as illustrated in view 150.

FIG. 3 illustrates an apparatus comprising a GRIN FAU block 308 coupled to the PIC 102. The GRIN FAU block 308 is an optical component comprising a graded index lens, GRIN lens 302 component, and a housing. The GRIN FAU block 308 is to implement a lens-to-lens system at an expanded beam connector (EBC) to GRIN lens 302 interface 371 on an FAU facing side. The FAU side of the GRIN FAU block 308 may be oriented to optically communicate with an expanded beam coupler (EBC) or means for beam expansion. In some embodiments, the EBC or means for beam expansion is implemented as a compact MLA 304 jumper array to the FAU 306, or alternatively as a GRIN lens jumper array to the FAU 306. As used herein, “jumper array” refers to a fiber array connector for connecting the GRIN lens block 308 an external component or outside rack I/O component. The GRIN FAU block 308 may be assembled on a package substrate.

The architecture of the GRIN FAU block 308 is to optically couple the GRIN lens 302 component and the PIC 102, as illustrated, to secure optical coupling between the PIC 102 and the FAU 306. As shown in top view 300, to provide this optical coupling, a portion of the GRIN lens 302 component is configured to couple to the array coupler interface 106, located at the edge of the PIC die 102.

In some embodiments, the GRIN FAU block 308 optically couples to the PIC 102 die via a sliding joint. The sliding joint is visually distinguishable, as it is characterized by a V-groove in a surface of the PIC die, as described above, and a feature or fiber-shaped GRIN lens extending from the GRIN FAU block 308 into the V-groove and contacting two opposing sidewalls in the V-groove. With reference back to FIG. 2A, in some embodiments, the GRIN lens 302 component includes a fiber-shaped GRIN lens (e.g., a cylinder with a 125 micron diameter), as indicated with feature 212 to extend orthogonally downward in the Z direction or from a lower surface, to mate with, or fit into, respective V-grooves (108-1 and 108-2). Accordingly, the GRIN lens 302 component may have a cross-sectional profile that is at least partially fiber-shaped and mate with the V-grooves to form a sliding joint by contacting two opposing side walls of the V-groove; the sliding joint is a means for passive-active alignment, in that it enables a passive pick and place alignment action and an active alignment action. The sliding joint comprises a component of the PIC die and a component of the GRIN FAU block 308, and the sliding joint is sandwiched between the PIC die and the GRIN FAU block 308, or at a seam between them.

In a package assembly process, a passive alignment aspect of the present disclosure includes using moderate precision pick and place equipment to assemble the components such that GRIN lens extends from the GRIN lens 302 component into a respective V-groove 208 in the PIC die 102. This process is also referred to as mating the GRIN lens into the V-groove. An alignment tolerance 204 is a measurement between the longitudinal axis of the V-groove and a longitudinal axis of the respective feature 212 of the GRIN lens 302 component, as shown. As mentioned, this passive alignment tolerance 204 can be achieved using moderate precision pick and place equipment. By using the optional optical align fiducial markers for passive alignment, the GRIN lens 302 can be placed in an expected optimal position for optical coupling, i.e., a first order alignment process. Upon completion of the passive alignment process, the sliding joint is created, and the components are restrained to one degree of freedom of movement (the X direction in the figures).

Reference is made herein to a fiber array unit, or FAU. In various embodiments, the FAU 306 comprises a glass substrate with an embedded fiber optic array to optically couple to the array coupler interface 106 of the PIC 102. In various aspects of the disclosure, a plurality of waveguides, a plurality of optical fibers 310 (e.g., the herein referenced SMF), or a combination thereof, extending outward from the FAU 306, often off-package. Alternatively, the FAU 306 may comprise at least one waveguide or optical fiber 310. The optical fibers in the FAU are a conduit for optical light at a given wavelength and MFD. As used herein, the “glass” of the glass substrate can be an alkali-free alkaline earth boro-aluminosicilate glass, such as a glass comprising aluminum, oxygen, boron, silicon, and an alkaline-earth metal (e.g., beryllium, magnesium, calcium, strontium, barium, radium, such as a glass comprising SiO₂, Al₂O₃, B₂O₃, and MgO), or a photosensitive glass (photomachineable or photostructurable glass). In some embodiments, a photosensitive glass can be a glass that belongs to the lithium-silicate family of glass (e.g., a glass comprising lithium, silicon, and oxygen) comprising metallic particles, such as gold, silver, or other suitable metallic particles.

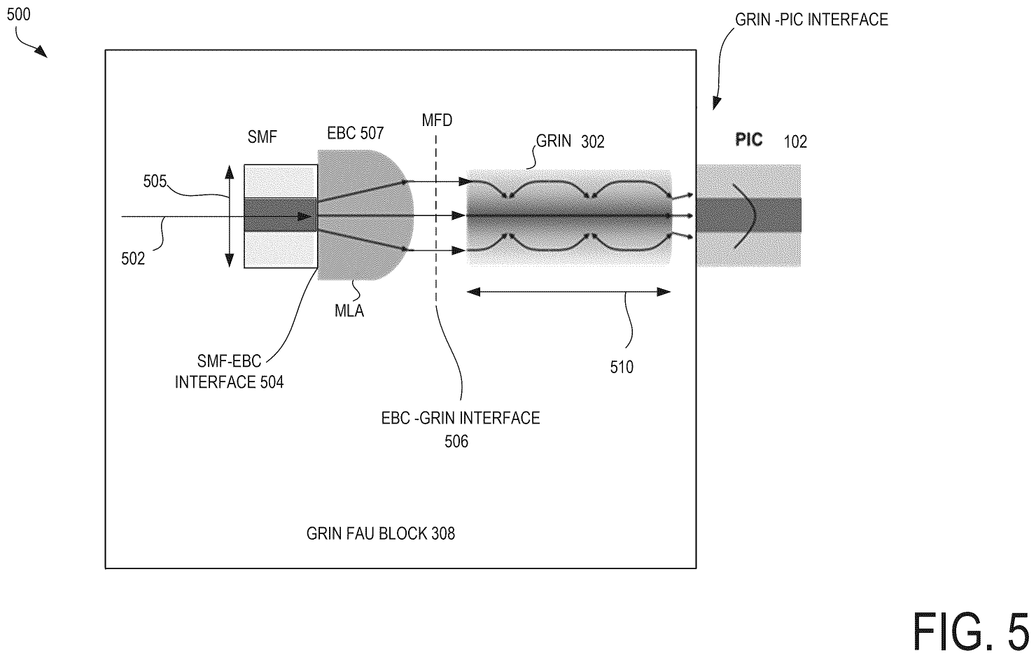

The compact MLA 304 is attached to individual fiber tips (e.g., individual SMF 310) to create an EB projected toward and impinging on the GRIN lens 302 component. This is also illustrated as the SMF-EB coupler interface (see, e.g., SMF-EBC interface 504, FIG. 5). The compact MLA, performing the function of an expanded beam coupler (EBC 507, FIG. 5), is a means for expanding a beam and is to expand the MFD of the SMF (FAU) to the spot size converter SSC or MFD of the PIC at the EBC to GRIN interface.

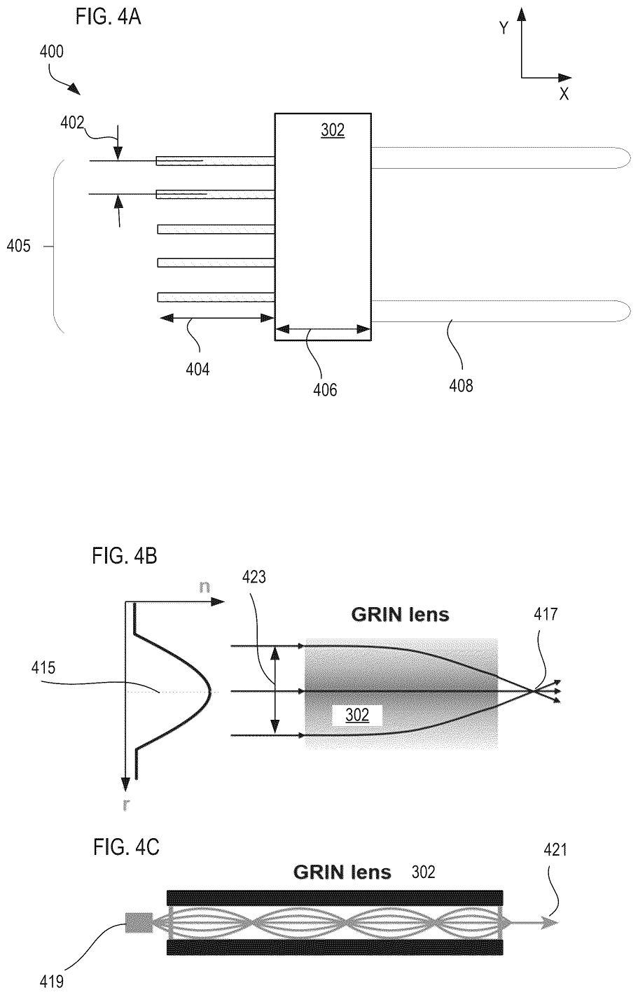

Embodiments provide expanded beam coupling between the FAU 306 and the PIC 102 die, based in part on a GRIN lens. FIG. 4A embodiment 400 illustrates an exemplary GRIN lens 302 component in more detail. A GRIN lens is a special type of lens with a refractive index that varies across the material. As illustrated in FIG. 4B, instead of having a uniform refractive index like a traditional spherical lens, a GRIN lens 302 has a radial gradient refractive index profile. This radial gradient in the refractive index allows the GRIN lens to bend light like a convex lens but does not require a curved-edge impingement surface.

Embodiments implement the GRIN lens 302 component with an adjustable length, and the mode field diameter (MFD) of the adjustable length GRIN lens component is adaptive to the PIC spot-size converter (SSC) output diameter (simplified to “spot size”) of the waveguides in the PIC. The GRIN lens 302 component has a plurality of optical fibers 405 extending toward the PIC 102 (only five optical fibers 405 are illustrated for simplicity, but the number in practice may match the number of optical waveguides in the PIC 102). The adjustable length of the GRIN lens 302 component comprises the first length 404 (external) of optical fibers 405 plus the second length 406 (internal). The pitch 402 plus the adjustable length determines the periodic beam phenomenon of the GRIN lens 302, illustrated in FIG. 4C.

Various embodiments of the GRIN lens 302 component include a GRIN lens of 125 μm (microns) diameter 423 (generally the same size as a single mode fiber (SMF) cladding diameter) and glass housing with an adjustable GRINS lens length. Embodiments can provide the functionality of a convex lens of up to 80 μm of expanded beam (EB) width/diameter, as well as the functionality of a mode field diameter (MFD) adaptor; this flexibility can be achieved by varying the GRIN lens length.

On the left in FIG. 4B, a graph indicates the radius on the vertical axis and the refractive index “n” extending to the right on the page. To the right of the graph, a simplified image of a GRIN lens is illustrated, matched up with the graph, with a GRIN lens longitudinal axis 415 depicted by a dashed line through its center, which bisects the diameter 423. At the GRIN lens longitudinal axis 415, in the center of the GRIN lens, the refractive index (n) is the largest. The magnitude falls off or declines radially outward from longitudinal axis 415, which can be seen by tracing the “n” curve away from the center axis, in the upward or downward direction. Although FIG. 4B is depicted in two dimensions, it may be appreciated that in practice, the radial gradient profile is three dimensional. The simplified GRIN lens illustration depicts parallel light waves entering it at the left and the light waves bending such that they converge (point 417) just outside of the GRIN lens on the right.

This feature of a GRIN lens facilitates the GRIN lens to be made with a diameter 423 that is as small as the diameter of the SMF (e.g., 125 μm). The small diameter 423 and compatibility with SMF advantageously make the GRIN lens fully compatible with the V-groove structures present on the PIC, enabling it to be integrated into available industry standard V-groove alignment features using the existing fiber-PIC direct attachment process, and enables it to be integrated onto the PIC package with a highly compact packaged dimension. Moreover, due to the gradient index profile, the propagation of light inside the GRIN lens 302 is periodic (equivalent to a lens series). Consequently, the GRIN lens possesses the capability to concurrently achieve beam collimation and guidance. This feature obviates the need for a segment of SMF to guide the optical mode to PIC after the beam collimation, thereby improving coupling loss in comparison to the solution using the conventional MLAs, as described above.

FIG. 4C illustrates the periodic beam phenomenon mentioned above, which is the propagation of light within a GRIN lens. The light from source 419 represents an optical beam output from a light source or optical fiber (e.g. SMF) in the FAU. After leaving the optical fiber, the optical beam may traverse through a MLA and spread out in three dimensions (although rendered in two dimensions in the figure) to a MFD as it impinges on the GRIN lens 302 component at the first side. The GRIN lens 302 sharpens or focuses the beam, which exits the GRIN lens at the second side at 421. The optical light completes a predetermined whole number of complete cycles in the GRIN lens. In this exemplary illustration, the light completes two whole periodic cycles before exiting as substantially parallel light at 421.

For optimal optical power, it is desirable to have convergence of the focusing beam 421 at the entrance of the core of a respective waveguide in the PIC 102. As used here, the core of the GRIN lens is its longitudinal axis (415), and the entrance or first side of the core can alternatively be viewed as the center of a circle representing the cross-sectional input to the GRIN lens.

In practice, the GRIN lens may be one of a plurality of GRIN lenses arranged in an array at a predetermined pitch. In an example, the pitch capability is 250 microns. In another example, the pitch capability is 127 microns, and the fibers have lens diameter of 125 microns+/−10% and adjacent or side-by-side. In other embodiments, the GRIN lens diameter and the corresponding pitch can be reduced. In another non-limiting example GRIN lens 302 component, the longitudinal or optical pitch indicated in FIG. 4C is 2.25 microns+/−10%, the first length 404 is 3 millimeters+/−10% and the second length 406 is 2.58 millimeters+/−10%. In some embodiments, this GRIN lens embodiment may have the dimensions 5.58 millimeters+/−10 microns. Connectors 408 are to connect with receiving jumper arrays (e.g., MLA or GRIN, mentioned above) to complete an expanded beam lens-to-lens solution or system.

In an example, embodiments can work with small MFDs (wherein “small” means about 3 to 5 microns plus or minus 10%) so that SSC design can be simplified, e.g., with a membrane and undercut for better yield and reliability performance. In another example, a GRIN lens can achieve a relatively large MFD (wherein “large” means less than or equal to 80 microns, plus or minus 10%). Therefore, advantageously, embodiments are compatible with a variety of PIC spot-size converter (SSC) designs with different mode field diameters (MFD), without requiring a complex SSC design and substrate undercut.

In contrast, some other solutions require that a micro lens array (MLA) be attached or be printed onto a PIC die facet, the provided GRIN lens itself enables expanded beam functionality without needing a micro lens array (MLA) block to be attached or be printed onto a PIC die facet. The provided GRIN lens also enables a more compact form factor micro lens array than many other solutions, such as those that implement a micro lens array (MLA) block.

Summarizing the above, scalability can be achieved by customizing the GRIN lens. Various parameters of the GRIN lens 302 can be customized to adapt to the requirements of different PIC die output mode field diameters (MFD) at the source 419. Examples of parameters that can be customized include NA (numerical aperture), RI (refractive index), and RI gradient profile.

FIG. 5 illustrates a simplified cross-sectional image 500 for a GRIN-lens EB coupler for detachable FAU. In this configuration, the optical beam 502 exiting the SMF (e.g., SMF 310) is expanded via the EBC 507 (which, in this example, is a MLA attached to the SMF fiber tip) at the SMF-EB coupler interface 504. The EBC 507 in the form of an MLA expands the optical beam from the SMF to an MFD; this corresponds to the EBC to GRIN lens 302 interface 371 of FIG. 3. Subsequently, the expanded beam that emerges from the EBC 507 crosses the EB coupler-GRIN interface 506, impinges on, and is converged by the GRIN lens 302. For a plurality of optical fibers 310 (e.g., a plurality of SMF), this illustrated pathway is performed for individual optical fibers of the plurality of optical fibers, concurrently.

In a non-limiting example, the SMF has a diameter of 125 microns. In various embodiments, the MLA comprises silicon. In an embodiment, the MFD at the EBC Grin interface 506 is 23 microns+/−5 microns. In various aspects of the invention, the GRIN 508 has length 510 is 4.39 millimeters+/−10 microns.

In various proof-of-concept experiments, using the provided GRIN-lens EB coupler for detachable FAU approach has advantageously increased the offset tolerance between the SMF and the PIC (up to 20 μm), thus enabling the EBC-GRIN interface 506 to be configured as a pluggable user-interface; this is a function of at least the expanded beam size (up to 80 μm) exiting the EBC 507. The nominal coupling loss in some of the proof-of-concept experiments was observed to be less than 0.01 dB, with the expanded beam diameter interposed between the lenses approximating 25 microns. It is worth noting that the example embodiments discussed herein are sample designs to show the feasibility and benefits of this architecture and method. With a lower NA GRIN lens, the expanded beam (EB) diameter can potentially be enhanced to 80 microns or more. Under such conditions, the lateral offset tolerance can be further improved to approximately 20 microns (a 10-time improvement over direct coupling).

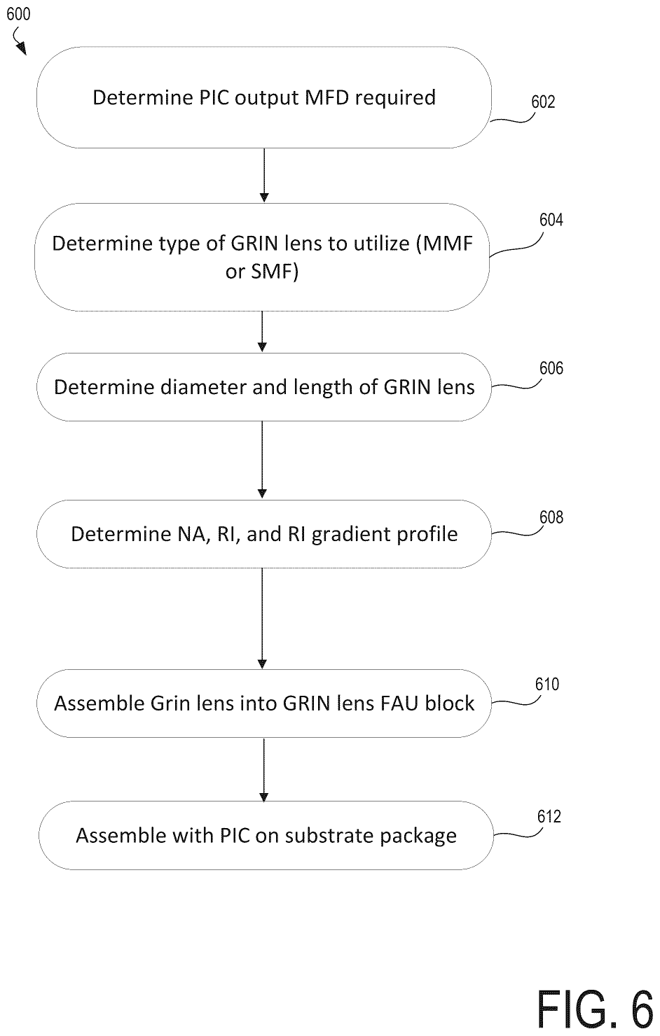

A method 600 for GRIN-lens EB coupler for detachable FAU is provided in FIG. 6. At 602, a spot size requirement for a target PIC is determined. Recall, this also represents the target MFD of the PIC, spot size has been used to distinguish it from the MFD of the fiber in the FAU. As mentioned, various PIC technologies have various Spot Size Converter (SSC) requirements or resulting spot sizes between the PIC silicon waveguides and optical fibers of a FAU. Embodiments determine a target MFD for the optical fibers in the FAU.

At 604 a GRIN lens is selected to convert between the target MFD and the spot size. This may include selecting a type of GRIN lens to utilize. One option is to use a plurality of GRIN lens segments comprising multi-mode fiber (MMF). GRIN MMF is designed with a gradient index profile within the core of the fiber, enabling it to realize the same collimating function as that of a GRIN lens. Utilizing GRIN MMF is a notably cost-effective option. In an example embodiment, the GRIN lens segments have a diameter ranging from 3 to 6 millimeters. Consequently, a single meter of GRIN MMF can be diced into hundreds of GRIN lens segments for use in the package. Nevertheless, the limitation of this approach is that the GRIN MMF only possesses a gradient index within the fiber core, not in the cladding. For available GRIN MMF a common core size is 50 microns, and the maximum beam size allowed is about 30 microns, allowing about 20 microns for the evanescent field around it. Since the offset tolerance of the EB coupler is proportional to the expanded beam diameter, using GRIN MMF will ultimately limit the maximum tolerance performance.

Another option is using a standard GRIN lens with a reduced diameter of 125 microns, consistent with that of a single mode fiber (SMF). This type of GRIN lens is usually fabricated from a standard GRIN lens possessing larger diameter but undergoing an isotropic chemical etch to reduce the lens rod diameter. The primary benefit of employing a standard GRIN lens is the absence of the cladding layer, resulting in the ability to use the entire lens cross-section for beam collimation, thereby enabling it to receive larger expanded beam diameters and increase alignment tolerance. Another benefit of this approach is that certain manufacturers specifically optimize for reduced lens aberration in their GRIN lens, whereas aberration is not a primary performance consideration in GRIN MMF. The reduced aberration serves to minimize the wavefront distortion during the beam propagation, and the coupling loss is significantly reduced as compared to using the GRIN MMF, especially as the GRIN lens length 510 gets longer. Nevertheless, standard GRIN lenses typically possess a higher cost compared to using segments of GRIN MMF.

At 606, the diameter and length of the GRIN lens is determined. As may be appreciated, the task at 606 is a function of the determination made at 604. At 608, the numerical aperture (NA), refractive index (RI) and RI gradient profile may be selected. In other variations of this method, the determinations made at 608 are also considered at 604.

At 610, the components are assembled into the GRIN lens FAU block, as described hereinabove. At 612, the product from 610 may be assembled with the PIC on a substrate package. Various embodiments may be assembled with electronic integrated circuit dies or chiplets and may be assembled with other photonic integrated circuits. Embodiments described herein may be found coupled to or packaged into a variety of packages, devices, and products, as described below.

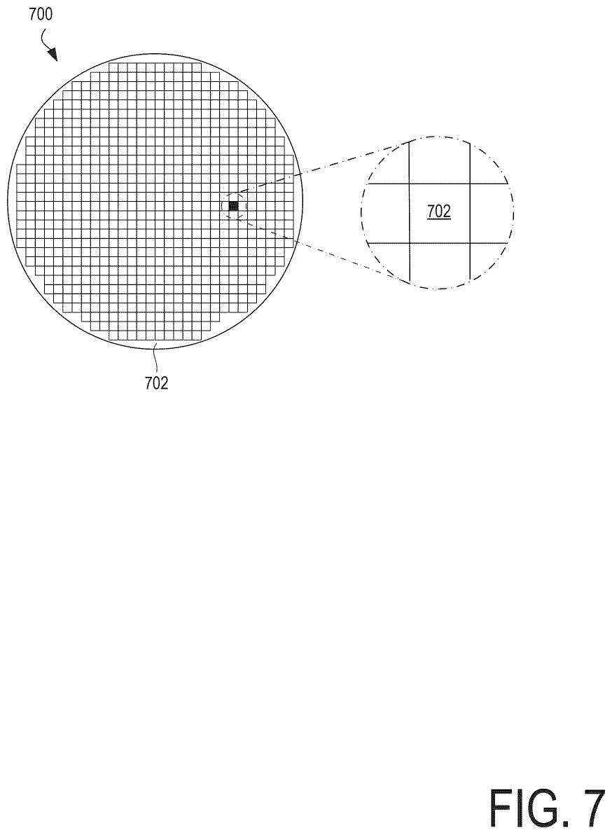

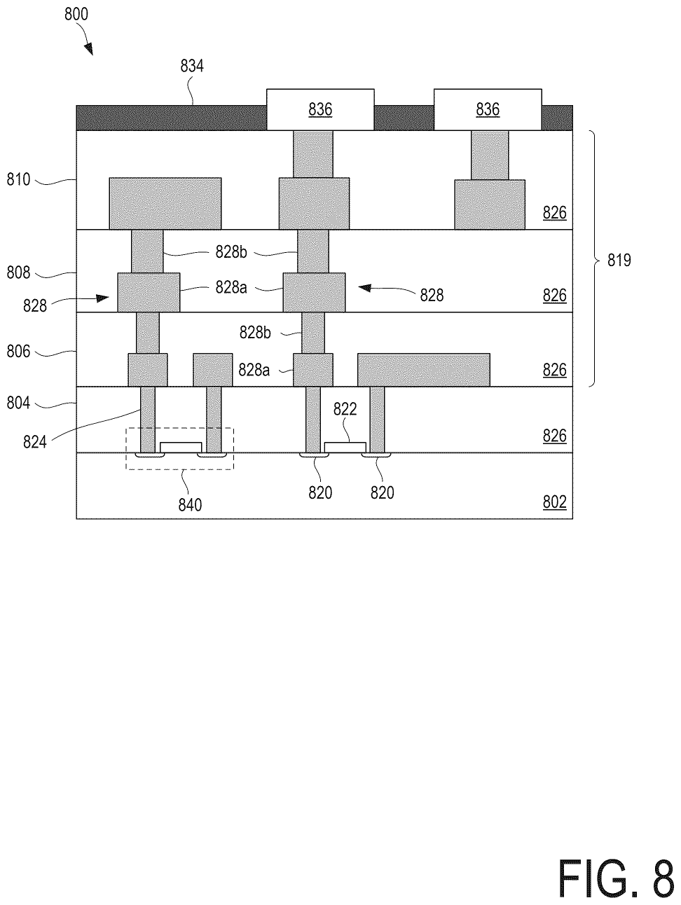

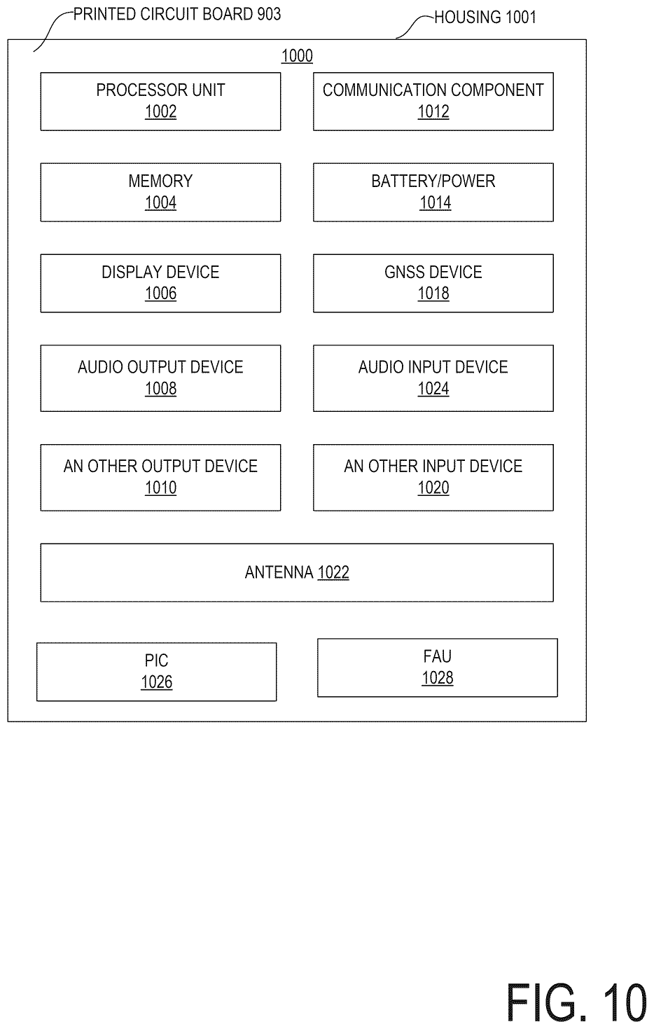

FIG. 7 is a top view of a wafer 700 and dies 702 that may be included in any of the embodiments disclosed herein. The wafer 700 may be composed of semiconductor material and may include one or more dies 702 formed on a surface of the wafer 700. After the fabrication of the integrated circuit components on the wafer 700 is complete, the wafer 700 may undergo a singulation process in which the dies 702 are separated from one another to provide discrete “chips” or destined for a packaged integrated circuit component. The individual dies 702, comprising an integrated circuit component, may include one or more transistors (e.g., some of the transistors 840 of FIG. 8, discussed below), supporting circuitry to route electrical signals to the transistors, passive components (e.g., signal traces, resistors, capacitors, or inductors), and/or any other integrated circuit components. In some embodiments, the wafer 700 or the die 702 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 702. For example, a memory array formed by multiple memory devices may be formed on a same die 702 as a processor unit (e.g., the processor unit 1002 of FIG. 10) or other logic that is configured to store information in the memory devices or execute instructions stored in the memory array. In some embodiments, a die 702 may be attached to a wafer 700 that includes other die, and the wafer 700 is subsequently singulated, this manufacturing procedure is referred to as a die-to-wafer assembly technique.

FIG. 8 is a cross-sectional side view of an integrated circuit 800 that may be included in any of the embodiments disclosed herein. One or more of the integrated circuits 800 may be included in one or more dies 702 (FIG. 7). The integrated circuit 800 may be formed on a die substrate 802 (e.g., the wafer 700 of FIG. 7) and may be included in a die (e.g., the die 702 of FIG. 7).

The die substrate 802 may be a semiconductor substrate composed of semiconductor material systems including, for example, n-type or p-type materials systems (or a combination of both). The die substrate 802 may include, for example, a crystalline substrate formed using a bulk silicon or a silicon-on-insulator (SOI) substructure. In some embodiments, the die substrate 802 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 802. Although a few examples of materials from which the die substrate 802 may be formed are described here, any material that may serve as a foundation for an integrated circuit 800 may be used. The die substrate 802 may be part of a singulated die (e.g., the dies 702 of FIG. 7) or a wafer (e.g., the wafer 700 of FIG. 7).

The integrated circuit 800 may include one or more device layers 804 disposed on the die substrate 802. The device layer 804 may include features of one or more transistors 840 (e.g., metal oxide semiconductor field-effect transistors (MOSFETs)) formed on the die substrate 802. The transistors 840 may include, for example, one or more source and/or drain (S/D) regions 820, a gate 822 to control current flow between the S/D regions 820, and one or more S/D contacts 824 to route electrical signals to/from the S/D regions 820.

The gate 822 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 840 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 840 along the source-channel-drain direction, the gate electrode may comprise a U-shaped structure that includes a bottom portion substantially parallel to the surface of the die substrate 802 and two sidewall portions that are substantially perpendicular to the top surface of the die substrate 802. In other embodiments, at least one of the metal layers that form the gate electrode may simply be a planar layer that is substantially parallel to the top surface of the die substrate 802 and does not include sidewall portions substantially perpendicular to the top surface of the die substrate 802. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 820 may be formed within the die substrate 802 adjacent to the gate 822 of individual transistors 840. The S/D regions 820 may be formed using an implantation/diffusion process or an etching/deposition process, for example. In the former process, dopants such as boron, aluminum, antimony, phosphorous, or arsenic may be ion-implanted into the die substrate 802 to form the S/D regions 820. An annealing process that activates the dopants and causes them to diffuse farther into the die substrate 802 may follow the ion-implantation process. In the latter process, the die substrate 802 may first be etched to form recesses at the locations of the S/D regions 820. An epitaxial deposition process may then be conducted to fill the recesses with material that is used to fabricate the S/D regions 820. In some implementations, the S/D regions 820 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 820 may be formed using one or more alternate semiconductor materials such as germanium or a group III-V material or alloy. In further embodiments, one or more layers of metal and/or metal alloys may be used to form the S/D regions 820.

Electrical signals, such as power and/or input/output (I/O) signals, may be routed to and/or from the devices (e.g., transistors 840) of the device layer 804 through one or more interconnect layers disposed on the device layer 804 (illustrated in FIG. 8 as interconnect layers 806-810). For example, electrically conductive features of the device layer 804 (e.g., the gate 822 and the S/D contacts 824) may be electrically coupled with the interconnect structures 828 of the interconnect layers 806-810. The one or more interconnect layers 806-810 may form a metallization stack (also referred to as an “ILD stack”) 819 of the integrated circuit 800.

The interconnect structures 828 may be arranged within the interconnect layers 806-810 to route electrical signals according to a wide variety of designs; in particular, the arrangement is not limited to the particular configuration of interconnect structures 828 depicted in FIG. 8. Although a particular number of interconnect layers 806-810 is depicted in FIG. 8, embodiments of the present disclosure include integrated circuits having more or fewer interconnect layers than depicted.

In some embodiments, the interconnect structures 828 may include lines 828a and/or vias 828b filled with an electrically conductive material such as a metal. The lines 828a may be arranged to route electrical signals in a direction of a plane that is substantially parallel with a surface of the die substrate 802 upon which the device layer 804 is formed. For example, the lines 828a may route electrical signals in a direction in and out of the page and/or in a direction across the page. The vias 828b may be arranged to route electrical signals in a direction of a plane that is substantially perpendicular to the surface of the die substrate 802 upon which the device layer 804 is formed. In some embodiments, the vias 828b may electrically couple lines 828a of different interconnect layers 806-810 together.

The interconnect layers 806-810 may include a dielectric material 826 disposed between the interconnect structures 828, as shown in FIG. 8. In some embodiments, dielectric material 826 disposed between the interconnect structures 828 in different ones of the interconnect layers 806-810 may have different compositions; in other embodiments, the composition of the dielectric material 826 between different interconnect layers 806-810 may be the same. The device layer 804 may include a dielectric material 826 disposed between the transistors 840 and a bottom layer of the metallization stack as well. The dielectric material 826 included in the device layer 804 may have a different composition than the dielectric material 826 included in the interconnect layers 806-810; in other embodiments, the composition of the dielectric material 826 in the device layer 804 may be the same as a dielectric material 826 included in any one of the interconnect layers 806-810.

A first interconnect layer 806 (referred to as Metal 1 or “M1”) may be formed directly on the device layer 804. In some embodiments, the first interconnect layer 806 may include lines 828a and/or vias 828b, as shown. The lines 828a of the first interconnect layer 806 may be coupled with contacts (e.g., the S/D contacts 824) of the device layer 804. The vias 828b of the first interconnect layer 806 may be coupled with the lines 828a of a second interconnect layer 808.

The second interconnect layer 808 (referred to as Metal 2 or “M2”) may be formed directly on the first interconnect layer 806. In some embodiments, the second interconnect layer 808 may include via 828b to couple the interconnect structures 828 of the second interconnect layer 808 with the lines 828a of a third interconnect layer 810. Although the lines 828a and the vias 828b are structurally delineated with a line within individual interconnect layers for the sake of clarity, the lines 828a and the vias 828b may be structurally and/or materially contiguous (e.g., simultaneously filled during a dual-damascene process) in some embodiments.

The third interconnect layer 810 (referred to as Metal 3 or “M3”) (and additional interconnect layers, as desired) may be formed in succession on the second interconnect layer 808 according to similar techniques and configurations described in connection with the second interconnect layer 808 or the first interconnect layer 806. In some embodiments, the interconnect layers that are “higher up” in the metallization stack 819 in the integrated circuit 800 (i.e., farther away from the device layer 804) may be thicker that the interconnect layers that are lower in the metallization stack 819, with lines 828a and vias 828b in the higher interconnect layers being thicker than those in the lower interconnect layers.

The integrated circuit 800 may include a solder resist material 834 (e.g., polyimide or similar material) and one or more conductive contacts 836 formed on the interconnect layers 806-810. In FIG. 8, the conductive contacts 836 are illustrated as taking the form of bond pads. The conductive contacts 836 may be electrically coupled with the interconnect structures 828 and configured to route the electrical signals of the transistor(s) 840 to external devices. For example, solder bonds may be formed on the one or more conductive contacts 836 to mechanically and/or electrically couple an integrated circuit die including the integrated circuit 800 with another component (e.g., a printed circuit board). The integrated circuit 800 may include additional or alternate structures to route the electrical signals from the interconnect layers 806-810; for example, the conductive contacts 836 may include other analogous features (e.g., posts) that route the electrical signals to external components.

In some embodiments in which the integrated circuit 800 is a double-sided die, the integrated circuit 800 may include another metallization stack (not shown) on the opposite side of the device layer(s) 804. This metallization stack may include multiple interconnect layers as discussed above with reference to the interconnect layers 806-810, to provide conductive pathways (e.g., including conductive lines and vias) between the device layer(s) 804 and additional conductive contacts (not shown) on the opposite side of the integrated circuit 800 from the conductive contacts 836.

In other embodiments in which the integrated circuit 800 is a double-sided die, the integrated circuit 800 may include one or more through silicon vias (TSVs) through the die substrate 802; these TSVs may make contact with the device layer(s) 804, and may provide conductive pathways between the device layer(s) 804 and additional conductive contacts (not shown) on the opposite side of the integrated circuit 800 from the conductive contacts 836. In some embodiments, TSVs extending through the substrate can be used for routing power and ground signals from conductive contacts on the opposite side of the integrated circuit 800 from the conductive contacts 836 to the transistors 840 and any other components integrated into the die having the integrated circuit 800, and the metallization stack 819 can be used to route I/O signals from the conductive contacts 836 to transistors 840 and any other components integrated into the die having the integrated circuit 800.

Multiple integrated circuits 800 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

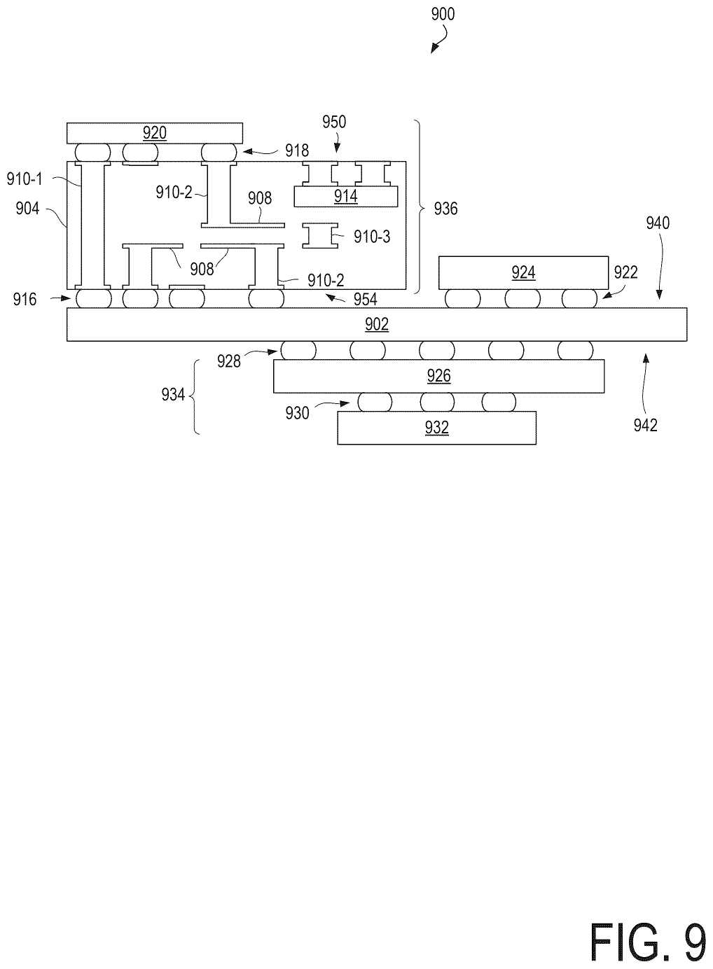

FIG. 9 is a cross-sectional side view of a microelectronic assembly 900 that may include any of the embodiments disclosed herein. The microelectronic assembly 900 includes multiple integrated circuit components disposed on a circuit board 902 (which may be a motherboard, system board, mainboard, etc.). The microelectronic assembly 900 may include components disposed on a first face 940 of the circuit board 902 and an opposing second face 942 of the circuit board 902; generally, components may be disposed on one or both faces 940 and 942.

In some embodiments, the circuit board 902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 902. In other embodiments, the circuit board 902 may be a non-PCB substrate. The microelectronic assembly 900 illustrated in FIG. 9 includes a package-on-interposer structure 936 coupled to the first face 940 of the circuit board 902 by coupling components 916. The coupling components 916 may electrically and mechanically couple the package-on-interposer structure 936 to the circuit board 902, and may include solder balls (as shown in FIG. 9), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 936 may include an integrated circuit component 920 coupled to an interposer 904 by coupling components 918. The coupling components 918 may take any suitable form for the application, such as the forms discussed above with reference to the coupling components 916. Although a single integrated circuit component 920 is shown in FIG. 9, multiple integrated circuit components may be coupled to the interposer 904; indeed, additional interposers may be coupled to the interposer 904. The interposer 904 may provide an intervening substrate used to bridge the circuit board 902 and the integrated circuit component 920.

The integrated circuit component 920 may be a packaged or unpackaged integrated circuit component that includes one or more integrated circuit dies (e.g., the die 702 of FIG. 7, the integrated circuit 800 of FIG. 8) and/or one or more other suitable components.

The unpackaged integrated circuit component 920 comprises solder bumps attached to contacts on the die. The solder bumps allow the die to be directly attached to the interposer 904. In embodiments where the integrated circuit component 920 comprises multiple integrated circuit dies; the dies can be of the same type (a homogeneous multi-die integrated circuit component) or of two or more different types (a heterogeneous multi-die integrated circuit component). In addition to comprising one or more processor units, the integrated circuit component 920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets.” In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof. A packaged multi-die integrated circuit component can be referred to as a multi-chip package (MCP) or multi-chip module (MCM).

Generally, the interposer 904 may spread connections to a wider pitch or reroute a connection to a different connection. For example, the interposer 904 may couple the integrated circuit component 920 to a set of ball grid array (BGA) conductive contacts of the coupling components 916 for coupling to the circuit board 902. In the embodiment illustrated in FIG. 9, the integrated circuit component 920 and the circuit board 902 are attached to opposing sides of the interposer 904; in other embodiments, the integrated circuit component 920 and the circuit board 902 may be attached to a same side of the interposer 904. In some embodiments, three or more components may be interconnected by way of the interposer 904.

In some embodiments, the interposer 904 may be formed as a PCB, including multiple metal layers separated from one another by layers of dielectric material and interconnected by electrically conductive vias. In some embodiments, the interposer 904 may be formed of an epoxy resin, a fiberglass-reinforced epoxy resin, an epoxy resin with inorganic fillers, a ceramic material, or a polymer material such as polyimide. In some embodiments, the interposer 904 may be formed of alternate rigid or flexible materials that may include the same materials described above for use in a semiconductor substrate, such as silicon, germanium, and other group III-V and group IV materials. The interposer 904 may include metal interconnects 908 and vias 910, including but not limited to through hole vias 910-1 (that extend from a first face 950 of the interposer 904 to a second face 954 of the interposer 904), blind vias 910-2 (that extend from the first or second faces 950 or 954 of the interposer 904 to an internal metal layer), and buried vias 910-3 (that connect internal metal layers).

In some embodiments, the interposer 904 can comprise a silicon interposer. Through silicon vias (TSV) extending through the silicon interposer can connect connections on the first face of a silicon interposer to an opposing second face of the silicon interposer. In some embodiments, an interposer 904 comprising a silicon interposer can further comprise one or more routing layers to route connections on a first face of the interposer 904 to an opposing second face of the interposer 904.

The interposer 904 may further include embedded devices 914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 904. The package-on-interposer structure 936 may take the form of any of the package-on-interposer structures known in the art. In embodiments where the interposer is a non-printed circuit board

The integrated circuit assembly 900 may include an integrated circuit component 924 coupled to the first face 940 of the circuit board 902 by coupling components 922. The coupling components 922 may take the form of any of the embodiments discussed above with reference to the coupling components 916, and the integrated circuit component 924 may take the form of any of the embodiments discussed above with reference to the integrated circuit component 920.

The integrated circuit assembly 900 illustrated in FIG. 9 includes a package-on-package structure 934 coupled to the second face 942 of the circuit board 902 by coupling components 928. The package-on-package structure 934 may include an integrated circuit component 926 and an integrated circuit component 932 coupled together by coupling components 930 such that the integrated circuit component 926 is disposed between the circuit board 902 and the integrated circuit component 932. The coupling components 928 and 930 may take the form of any of the embodiments of the coupling components 916 discussed above, and the integrated circuit components 926 and 932 may take the form of any of the embodiments of the integrated circuit component 920 discussed above. The package-on-package structure 934 may be configured in accordance with any of the package-on-package structures known in the art.

FIG. 10 is a block diagram of an example electrical device 1000 that may include one or more of the PIC 1026 and/or FAU 1028 embodiments disclosed herein. For example, any suitable ones of the components of the electrical device 1000 may include one or more of the package assemblies (e.g., multi-chip package (MCP), microelectronic assemblies 900, integrated circuit components 920, integrated circuits 800, integrated circuit dies 702, or structures disclosed herein. A number of components are illustrated in FIG. 10 as included in the electrical device 1000, but any one or more of these components may be omitted or duplicated, as suitable for the application. In some embodiments, some or all the components included in the electrical device 1000 may be attached to one or more motherboards, mainboards, printed circuit boards 1003, or system boards. In some embodiments, one or more of these components are fabricated onto a single system-on-a-chip (SoC) die. In various embodiments, the electrical device 900 is enclosed by, or integrated with, a housing 1001.

Additionally, in various embodiments, the electrical device 1000 may not include one or more of the components illustrated in FIG. 10, but the electrical device 1000 may include interface circuitry for coupling to the one or more components. For example, the electrical device 1000 may not include a display device 1006, but may include display device interface circuitry (e.g., a connector and driver circuitry) to which a display device 1006 may be coupled. In another set of examples, the electrical device 1000 may not include an audio input device 1024 or an audio output device 1008, but may include audio input or output device interface circuitry (e.g., connectors and supporting circuitry) to which an audio input device 1024 or audio output device 1008 may be coupled.

The electrical device 1000 may include one or more processor units 1002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 1000 may include a memory 1004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1004 may include memory that is located on the same integrated circuit die as the processor unit 1002. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1000 can comprise one or more processor units 1002 that are heterogeneous or asymmetric to another processor unit 1002 in the electrical device 1000. There can be a variety of differences between the processing units 1002 in a system in terms of a spectrum of metrics of merit including architectural, microarchitectural, thermal, power consumption characteristics, and the like. These differences can effectively manifest themselves as asymmetry and heterogeneity among the processor units 1002 in the electrical device 1000.

In some embodiments, the electrical device 1000 may include a communication component 1012 (e.g., one or more communication components). For example, the communication component 1012 can manage wireless communications for the transfer of data to and from the electrical device 1000. The term “wireless” and its derivatives may be used to describe circuits, devices, systems, methods, techniques, communications channels, etc., that may communicate data using modulated electromagnetic radiation through a nonsolid medium. The term “wireless” does not imply that the associated devices do not contain any wires, although in some embodiments they might not.

The communication component 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1012 may operate in accordance with other wireless protocols in other embodiments. The electrical device 1000 may include an antenna 1022 to facilitate wireless communications and/or to receive other wireless communications (such as AM or FM radio transmissions).

In some embodiments, the communication component 1012 may manage wired communications, such as electrical, optical, or any other suitable communication protocols (e.g., IEEE 802.3 Ethernet standards). As noted above, the communication component 1012 may include multiple communication components. For instance, a first communication component 1012 may be dedicated to shorter-range wireless communications such as Wi-Fi or Bluetooth, and a second communication component 1012 may be dedicated to longer-range wireless communications such as global positioning system (GPS), EDGE, GPRS, CDMA, WiMAX, LTE, EV-DO, or others. In some embodiments, a first communication component 1012 may be dedicated to wireless communications, and a second communication component 1012 may be dedicated to wired communications.

The electrical device 1000 may include battery/power circuitry 1014. The battery/power circuitry 1014 may include one or more energy storage devices (e.g., batteries or capacitors) and/or circuitry for coupling components of the electrical device 1000 to an energy source separate from the electrical device 1000 (e.g., AC line power).

The electrical device 1000 may include a display device 1006 (or corresponding interface circuitry, as discussed above). The display device 1006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1000 may include an audio output device 1008 (or corresponding interface circuitry, as discussed above). The audio output device 1008 may include any embedded or wired or wirelessly connected external device that generates an audible indicator, such speakers, headsets, or earbuds.

The electrical device 1000 may include an audio input device 1024 (or corresponding interface circuitry, as discussed above). The audio input device 1024 may include any embedded or wired or wirelessly connected device that generates a signal representative of a sound, such as microphones, microphone arrays, or digital instruments (e.g., instruments having a musical instrument digital interface (MIDI) output). The electrical device 1000 may include a Global Navigation Satellite System (GNSS) device 1018 (or corresponding interface circuitry, as discussed above), such as a Global Positioning System (GPS) device. The GNSS device 1018 may be in communication with a satellite-based system and may determine a geolocation of the electrical device 1000 based on information received from one or more GNSS satellites, as known in the art.

The electrical device 1000 may include another output device 1010 (or corresponding interface circuitry, as discussed above). Examples of the other output device 1010 may include an audio codec, a video codec, a printer, a wired or wireless transmitter for providing information to other devices, or an additional storage device.

The electrical device 1000 may include another input device 1020 (or corresponding interface circuitry, as discussed above). Examples of the other input device 1020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1000 may be any other electronic device that processes data. In some embodiments, the electrical device 1000 may comprise multiple discrete physical components. Given the range of devices that the electrical device 1000 can be manifested as in various embodiments, in some embodiments, the electrical device 1000 can be referred to as a computing device or a computing system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

As used herein, phrases such as “an embodiment,” “various embodiments,” “some embodiments,” and the like, indicate that some embodiments may have some, all, or none of the features described for other embodiments. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used herein, the term “electronic component” can refer to an active electronic circuit (e.g., processing unit, memory, storage device, FET) or a passive electronic circuit (e.g., resistor, inductor, capacitor).

As used herein, the term “integrated circuit component” can refer to an electronic component configured on a semiconducting material to perform a function. An integrated circuit (IC) component can comprise one or more of any computing system components described or referenced herein or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged integrated circuit component includes a single monolithic integrated circuit die (shortened herein to “die”); the die may include solder bumps attached to contacts on the die. When present on the die, the solder bumps or other conductive contacts can enable the die to be directly attached to a printed circuit board (PCB).

A non-limiting example of a packaged integrated circuit component comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps or leads attached to the package substrate for attaching the packaged integrated circuit component to a printed circuit board or motherboard.

As used in this application and the claims, a list of items joined by the term “at least one of” or the term “one or more of” can mean any combination of the listed terms. For example, the phrase “at least one of A, B or C” can mean A; B; C; A and B; A and C; B and C; or A, B, and C. Likewise, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc., means that all the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

### Examples

Example 1 is an apparatus, comprising: a graded index (GRIN) lens to optically couple a single mode fiber (SMF) in a fiber optic array (FAU) to a waveguide in a photonic integrated circuit (PIC); wherein the SMF is a conduit for optical light with a wavelength; wherein the waveguide comprises a spot size converter; and wherein the GRIN lens has a lens diameter that is a function of the spot size converter; wherein the GRIN lens has a length that is a function of a predetermined whole number of periodic cycles of the wavelength.

Example 2 includes the subject matter of Example 1, wherein the lens diameter is 125 microns, plus or minus 10%.

Example 3 includes the subject matter of Example 1 or Example 2, wherein the length is 5.58 millimeters plus or minus 10 microns.

Example 4 includes the subject matter of any one of Examples 1-3, wherein the GRIN lens is one of a corresponding plurality of GRIN lenses arranged in accordance with a pitch.

Example 5 includes the subject matter of Example 4, wherein the length is 5.58 millimeters, and the pitch is 2.25 microns plus or minus 10%.

Example 6 includes the subject matter of any one of Examples 1-5, wherein the GRIN lens provides a mode field diameter (MFD) of 23 microns, plus or minus 5 microns.

Example 7 includes the subject matter of any one of Examples 1-6, further comprising: a housing enclosing at least part of the GRIN lens; and the GRIN lens extending orthogonally from a lower surface of the housing to contact two opposing sides of a V-groove on the PIC.

Example 8 includes the subject matter of any one of Examples 1-5 and 7, further comprising a convex lens to convert optical light output from the SMF to a mode field diameter (MFD).

Example 9 is a system to optically couple a fiber optic array (FAU) to a photonic integrated circuit (PIC) die, the system comprising: a lens to optically couple a fiber in the FAU to a waveguide in the PIC die; wherein the lens has a first mode field diameter (MFD) that is a function of a spot size converter of the waveguide; and wherein the fiber is a conduit for optical light with a wavelength and a second MFD; wherein the GRIN lens has a length that is a function of a predetermined whole number of periodic cycles of the wavelength.

Example 10 includes the subject matter of Example 9, wherein the waveguide is one of a plurality of waveguides in the PIC die and the lens is one of a corresponding plurality of lenses arranged in accordance with a pitch.

Example 11 includes the subject matter of Example 10, wherein the pitch is 2.25 microns plus or minus 10%.

Example 12 includes the subject matter of any one of Examples 9-11, further comprising a means for expanding the second MFD to the first MFD, coupled between the FAU and the lens.

Example 13 includes the subject matter of any one of Examples 9-12, wherein the first MFD is 125 microns, plus or minus 10%.

Example 14 includes the subject matter of any one of Examples 9-13, wherein the length is 5.58 millimeters plus or minus 10 microns.

Example 15 includes the subject matter of Example 9, further comprising: a housing enclosing at least part of the lens; and the lens extending orthogonally from a lower surface of the housing to contact two opposing sides of a V-groove on the PIC die.

Example 16 includes the subject matter of Example 9, wherein the mode field diameter is 23 microns, plus or minus 5 microns.

Example 17 includes the subject matter of Example 9, further comprising: a package substrate coupled to the lens; wherein the FAU is detachably coupled to the package substrate.

Example 18 is a method for a graded index (GRIN) lens expanded beam (EB) coupler, the method comprising: determining a spot size requirement for a target photonic integrated circuit (PIC); determining a target mode field diameter (MFD); selecting a GRIN lens to convert between the target MFD and the spot size; and assembling the GRIN lens onto a package substrate.

Example 19 includes the subject matter of Example 18, further comprising: detachably attaching a fiber array unit (FAU) to the package substrate; wherein optical fibers in the FAU are optically coupled to the GRIN lens at a side.

Example 20 includes the subject matter of Example 19, further comprising: optically coupling a photonic integrated circuit (PIC) die to the GRIN lens opposite the side.

What is claimed is:

1. An apparatus, comprising:
a graded index (GRIN) lens to optically couple a single mode fiber (SMF) in a fiber optic array (FAU) to a waveguide in a photonic integrated circuit (PIC);
wherein the SMF is a conduit for optical light with a wavelength;
wherein the waveguide comprises a spot size converter; and
wherein the GRIN lens has lens diameter that is a function of the spot size converter;
wherein the GRIN lens has a length that is a function of a predetermined whole number of periodic cycles of the wavelength.

2. The apparatus of claim 1, wherein the lens diameter is 125 microns, plus or minus 10%.

3. The apparatus of claim 1, wherein the length is 5.58 millimeters plus or minus 10 microns.

4. The apparatus of claim 1, wherein the GRIN lens is one of a corresponding plurality of GRIN lenses arranged in accordance with a pitch.

5. The apparatus of claim 4, wherein the length is 5.58 millimeters, and the pitch is 2.25 microns plus or minus 10%.

6. The apparatus of claim 1, further comprising a mode field diameter (MFD) of 23 microns, plus or minus 5 microns.

7. The apparatus of claim 1, further comprising:
a housing enclosing at least part of the GRIN lens; and
the GRIN lens extending orthogonally from a lower surface of the housing to contact two opposing sides of a V-groove on the PIC.

8. The apparatus of claim 6, further comprising a convex lens to convert optical light output from the SMF to the MFD.

9. A system to optically couple a fiber optic array (FAU) to a photonic integrated circuit (PIC) die, the system comprising:
a lens to optically couple a fiber in the FAU to a waveguide in the PIC die;
wherein the lens has a first mode field diameter (MFD) that is a function of a spot size converter of the waveguide; and
wherein the fiber is a conduit for optical light with a wavelength and a second MFD;
wherein the lens has a length that is a function of a predetermined whole number of periodic cycles of the wavelength.

10. The system of claim 9, wherein the waveguide is one of a plurality of waveguides in the PIC die and the lens is one of a corresponding plurality of lenses arranged in accordance with a pitch.

11. The system of claim 10, wherein the pitch is 2.25 microns plus or minus 10%.

12. The system of claim 9, further comprising a means for expanding the second MFD to the first MFD, coupled between the FAU and the lens.

13. The system of claim 9, wherein the first MFD is 125 microns, plus or minus 10%.

14. The system of claim 9, wherein the length is 5.58 millimeters plus or minus 10 microns.

15. The system of claim 9, further comprising:
a housing enclosing at least part of the lens; and
the lens extending orthogonally from a lower surface of the housing to contact two opposing sides of a V-groove on the PIC die.

16. The system of claim 9, wherein the mode field diameter is 23 microns, plus or minus 10%.

17. The system of claim 9, further comprising:
a package substrate coupled to the lens;
wherein the FAU is detachably coupled to the package substrate.

18. A method for a graded index (GRIN) lens expanded beam (EB) coupler, the method comprising:
determining a spot size requirement for a target photonic integrated circuit (PIC);
determining a target mode field diameter (MFD) for coupling to an optical fiber in a fiber array unit (FAU);
selecting a GRIN lens to convert between the target MFD and the spot size requirement; and
assembling the GRIN lens onto a package substrate.

19. The method of claim 18, further comprising:
detachably attaching the FAU to the package substrate;
wherein optical fibers in the FAU are optically coupled to the GRIN lens at a side.

20. The method of claim 19, further comprising: optically coupling a photonic integrated circuit (PIC) die to the GRIN lens opposite the side.
